(19) United States
(12) Patent Application Publication
(10) Pub. No.: US 2006/0255736 A1
(43) Pub. Date: Nov. 16, 2006

(54) Discharge lamp comprising electrodes having a conical slip part

(75) Inventors: Jacobus Hubertus Anna Selen, Eindhoven (NL); Georges Marie Calon, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/568,017

(22) PCT Filed: Aug. 3, 2004
(86) PCT No.: PCT/IB04/51369

§ 371 Date: Feb. 10, 2006

(30) Foreign Application Priority Data
Aug. 15, 2003 (EP) 03102554.7

(51) Int. Cl. H01J 61/04; H01J 17/04

(52) U.S. Cl. 313/631; 313/491; 313/574

(57) ABSTRACT

A lamp vessel (3) of a discharge lamp comprises two electrodes (40), wherein a part of each electrode (40) extends in a plug (23) arranged at an end of the lamp vessel (3). The electrode (40) comprises a base part (41), through means of which the electrode (40) is fixed to the seal (23). Furthermore, the electrode (40) comprises an intermediate part (43) having a conical outer surface (44). An inner surface (51) of the plug (23) fits closely on the outer surface (44) of the intermediate part (43) of the electrode (40). In case the electrode (40) expands as a result of an increase of the temperature, the conical outer surface (44) of the electrode (40) slips with respect to the inner surface (51) of the plug (23), wherein stress build-up is avoided. In this way, breaking of the plug (23) is avoided.

The present invention relates to a discharge lamp, comprising: a sealed lamp vessel having a vessel wall enclosing a discharge space in which an ionisable filling is present, wherein the lamp vessel has two extended plugs; and two electrodes, wherein one part of each electrode extends in an aperture in a respective plug, wherein another part of each electrode extends in the discharge space.

A well-known example of a discharge lamp is a so-called high-pressure gas discharge lamp, which may for example be applied as a vehicle headlamp. For the purpose of ionising the filling of the discharge space, the known discharge lamp comprises two cylindrical electrodes, wherein each electrode is embedded in a plug of the lamp vessel. One part of each electrode extends in the respective plug, whereas another part extends in the discharge space. An end portion of the part of the electrode extending in the plug is connected to a molybdenum foil, which is connected to an external current conductor for supplying electric current to the electrode. It is very important that the ionisable filling remains in the discharge space, whatever the circumstances. Therefore, the part of the electrode extending through the plug is closely surrounded by the plug.

During operation of the discharge lamp, the temperature of both the electrode and the plug in which the electrode is partly extending, increases. As a result, the materials of both the electrode and the plug expand. In the discharge lamp, the electrode and the plug are manufactured from different materials, wherein the thermal expansion coefficient of the material of the electrode differs from the thermal expansion coefficient of the material of the plug. As the electrode is closely surrounded by the plug, the thermal expansion coefficient mismatch may lead to breaking of the plug, and failure of the discharge lamp.

According to the state of the art, various solutions have been proposed in order to avoid breaking of the plug as a result of the thermal expansion coefficient mismatch of the materials of the electrode and the surrounding plug. One of the known solutions is disclosed in US 2002/0031975. According to this solution, a small gap is formed between the electrode and the plug in order to enable the electrode to expand and contract freely inside the plug.

However, while solving the problem of breaking of the plug, the known solution introduces another problem, as will be explained in the following. The filling of the discharge space can freely flow in and out of the gap, leading to unpredictable behaviour of the discharge lamp. For example, when the temperature of the electrode increases significantly at the start of an operation period of the discharge lamp, the gap is closed, and the filling is rapidly displaced towards the discharge space, causing the filling to plash about at the place where it leaves the gap and enters the discharge space. Also, when the gap is opened between the electrode and the plug, and is filled with filling originating from the discharge space, the amount of filling in the discharge space is decreased. These effects of the solution according to which a gap is formed between the electrode and the plug affect the functioning of the discharge lamp by influencing the conditions prevailing in the discharge space.

It is an objective of the present invention to provide a solution to the problem of breaking of the plug as a result of the thermal expansion coefficient mismatch of the materials of the electrode and the surrounding plug, which does not have disadvantageous side-effects which influence the behaviour of the discharge lamp.

According to the invention the objective is achieved in a discharge lamp mentionned in the opening paragraph, comprising: a sealed lamp vessel having a vessel wall enclosing a discharge space in which an ionisable filling is present, wherein the lamp vessel has two extended plugs; and two electrodes, wherein one part of each electrode extends in an aperture in a respective plug, wherein another part of each electrode extends in the discharge space, and wherein each electrode comprises a slip part having a conical outer surface; wherein an inner surface of the aperture fits closely on the conical outer surface of the slip part of the electrode; and wherein slip between the inner surface of the aperture and the conical outer surface of the slip part of the electrode is allowed.

According to the present invention, the electrodes of the discharge lamp comprise a slip part having a conical outer surface. An inner surface of the aperture in the respective plug fits closely on the conical outer surface of the slip part of the electrode, in other words, no clearance is present between the inner surface of the aperture and the conical outer surface of the slip part of the electrode. Still, the inner surface of the aperture fits on the conical outer surface of the slip part of the electrode in such a way that slip between the surfaces is allowed, in other words, no bonding is present between the inner surface of the aperture and the conical outer surface of the slip part of the electrode.

The aperture in the plug may be a cavity in the plug, but may also be a trough-hole in the plug.

The statement that the slip part of the electrode has a conical outer surface implies that an outer diameter of the slip part is larger than the outer diameter of another side of the slip part, and that the outer diameter gradually decreases when going from the one side to the other side. Within the scope of the present invention, it is not necessary that the smallest outer diameter is equal to zero, in other words, it is not necessary that the slip part of the electrode is shaped as a complete cone. Instead, the slip part of the electrode may also be shaped as a truncated cone.

The plug fits closely on the electrode, whereas slip between the plug and the slip part of the electrode is allowed. An advantageous result of this design of the discharge lamp is that there is no danger of breaking of the plug as a result of the mismatch of the thermal expansion coefficients of the materials from which the electrode and the plug are manufactured, while the close fitting of the plug on the electrode is always maintained, also in case of a temperature increase or decrease of the plug and the electrode. For example, in a situation in which the temperature increases, the electrode expands, wherein both an axial length and a diameter of the electrode increase. Due to the fact that the slip part of the electrode is conical and that no bonding is present between the plug and the conical outer surface of the slip part, the expansion of the electrode causes the slip part of the electrode to slip with respect to the plug. In this way, stresses are substantially reduced with respect to the conventional situation in which no slip occurs between the cylindrical electrode and the surrounding plug, to such an extent that there is no danger of breaking of the plug.

Furthermore, contact between the plug and the electrode is maintained, and leaking out of the filling of the discharge space is avoided.

The present invention will now be explained in greater detail with reference to the figures, in which similar parts are indicated by the same reference signs, and in which:

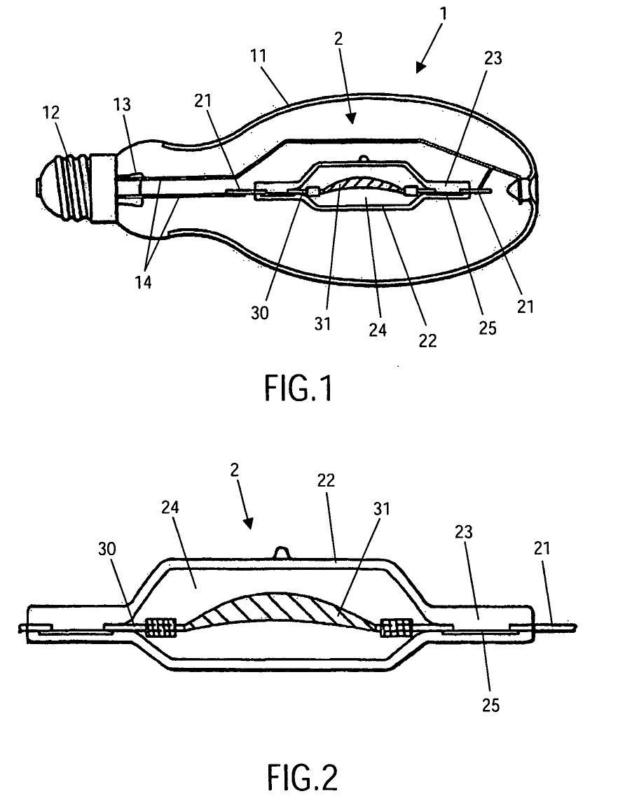

FIG. 1 diagrammatically shows a longitudinal section of a discharge lamp according to the state of the art;

FIG. 2 diagrammatically shows a longitudinal section of a lamp vessel of the discharge lamp as shown in FIG. 1;

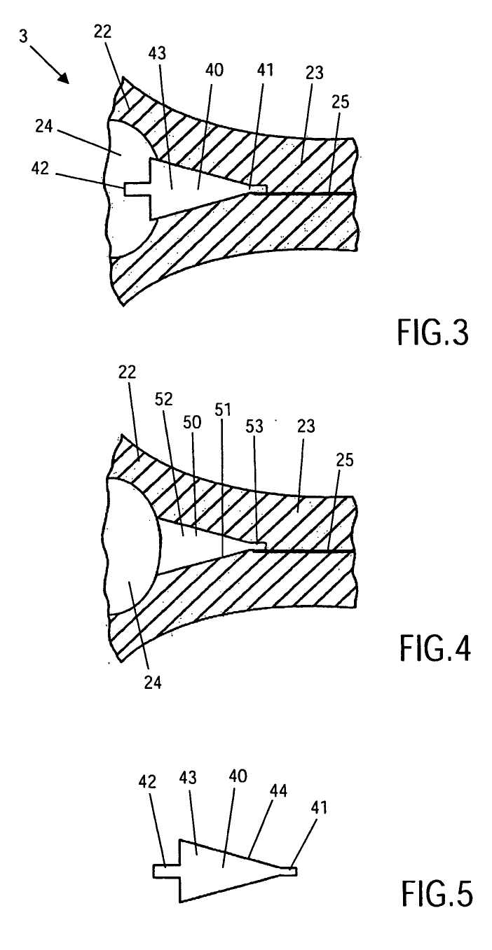

FIG. 3 diagrammatically shows a longitudinal section of a portion of a lamp vessel of a discharge lamp according to a first preferred embodiment of the present invention;

FIG. 4 diagrammatically shows a longitudinal section of the portion of the lamp vessel as shown in FIG. 3, wherein an electrode is omitted;

FIG. 5 shows a side view of an electrode that is part of the lamp vessel as shown in FIG. 3;

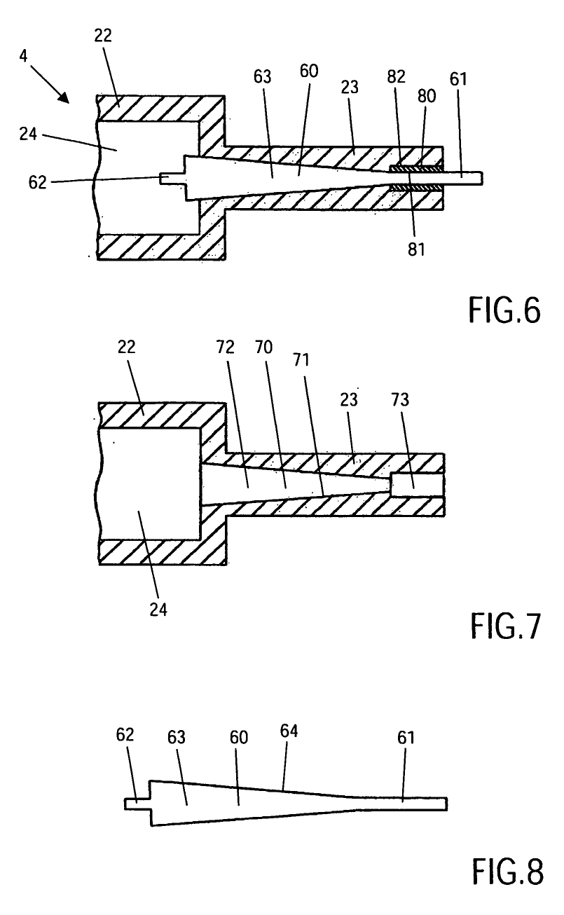

FIG. 6 diagrammatically shows a longitudinal section of a portion of a lamp vessel of a discharge lamp according to a second preferred embodiment of the present invention;

FIG. 7 diagrammatically shows a longitudinal section of the portion of the lamp vessel as shown in FIG. 6, wherein an electrode is omitted;

FIG. 8 shows a side view of an electrode that is part of the lamp vessel as shown in FIG. 6;

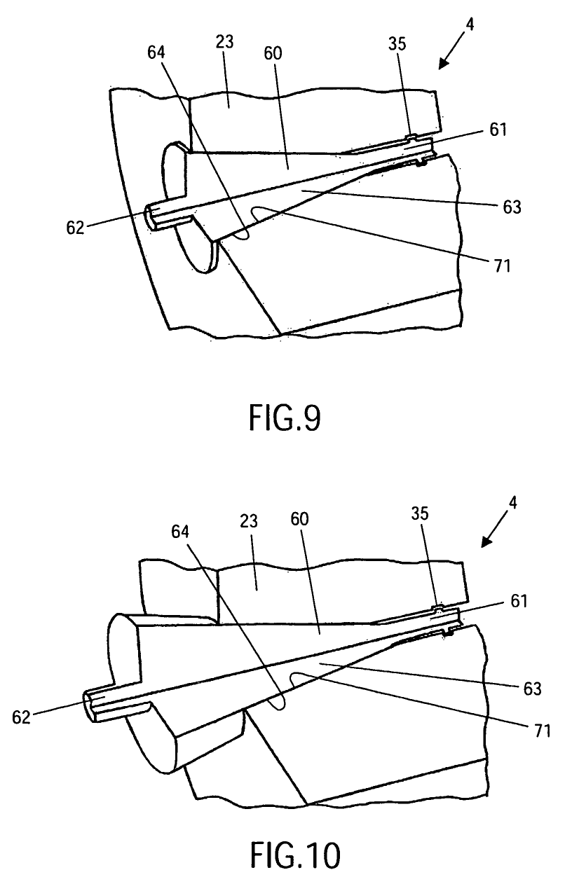

FIG. 9 diagrammatically shows a perspective view of the portion of the lamp vessel as shown in FIG. 6, at a relatively low temperature, wherein a section is cut out; and

FIG. 10 diagrammatically shows a perspective view of the portion of the lamp vessel as shown in FIG. 6, at a relatively high temperature, wherein a section is cut out.

A discharge lamp 1 according to the state of the art is shown in FIG. 1, whereas a tubular, light-transmissive lamp vessel 2 of the conventional discharge lamp 1 is shown in more detail in FIG. 2.

The lamp vessel 2 of the discharge lamp 1 is disposed inside an outer envelope 11, which is shaped as a bulb and which is connected to a lamp base 12 supporting a lamp stem 13. The discharge vessel 2 is connected to the lamp stem 13 by means of two connection conductors 14, which extend between the lamp stem 13 and external current conductors 21 projecting from the lamp vessel 2. During operation of the discharge lamp 1, the lamp vessel 2 is provided with electric current by means of the connection conductors 14, which are connected to respective contacts (not shown) on the lamp base 12.

According to the state of the art, there are various ways in which the lamp vessel 2 may be fixed inside a discharge lamp. For example, in another conventional discharge lamp (not shown), especially a discharge lamp that is used in projectors, one end of the lamp vessel is connected to a reflector of the discharge lamp by means of cement.

The lamp vessel 2 comprises a vessel wall 22 and two extended plugs 23 arranged at opposite ends of the lamp vessel 2. The vessel wall 22 and the plugs 23 are manufactured from a non-conducting material such as quartz glass. An inner space 24 of the lamp vessel 2 is filled with an ionisable filling comprising for example mercury, one or more metal halides and a rare gas such as argon. As during operation of the discharge lamp 1 a discharging process of the filling in the inner space 24 of the lamp vessel 2 takes place, the inner space 24 is commonly referred to as discharge space 24.

One part of the two external current conductors 21 projects from the lamp vessel 2, whereas another part is embedded in the respective plug 23, and is connected to a molybdenum foil 25 arranged inside the plug 23. In the lamp vessel 2, two opposite cylindrical electrodes 30 are arranged, wherein one part of each electrode 30 extends in the discharge space 24, and wherein another part of the electrode 30 extends in a respective plug 23. At an end that is positioned inside the plug 23, the electrode 30 is connected to the molybdenum foil 25. It will be understood that an important function of the molybdenum foil 25 is conducting electric current between the external current conductor 21 and the electrode 30, through the plug 23. Another important function of the molybdenum foil 25 is sealing the lamp vessel 2 in a gastight manner. The connection between the external current conductor 21 and the molybdenum foil 25 on the one hand and between the electrode 30 and the molybdenum foil 25 on the other hand is established by means of for example welding.

During operation of the discharge lamp 1, electric current is supplied to the electrodes 30, as a result of which the filling in the discharge space 24 is subjected to a discharging process. In case of the discharge lamp 1 having a horizontal position as shown in FIG. 1, a discharge arc 31 as depicted in FIGS. 1 and 2 by means of a hatched band is obtained. During the discharging process, light and heat are generated. Part of the generated heat is dissipated by the electrodes 30, the vessel wall 22 and the plugs 23, and the temperatures of these components of the discharge lamp 1 increase. As a result, the materials of these components of the discharge lamp 1 expand, wherein the various materials expand to different extents, which may lead to breaking of the plugs 23. In this respect, a run-up phase at the start of an operation period of the discharge lamp 1 is most critical, but breaking of the plugs 23 may also occur during an operation period.

According to the present invention, a discharge lamp is provided, wherein the design of the lamp vessel differs from the design of the conventional lamp vessel 2, such that breaking of the plugs 23 due to a thermal expansion coefficient mismatch of the materials of the electrodes 30 and the plugs 23 is avoided. In the following, a lamp vessel of a discharge lamp according to two preferred embodiments of the present invention will be discussed with reference to FIGS. 3-10.

In FIG. 3, a small portion of the vessel wall 22, a portion of one plug 23, a portion of the molybdenum foil 25 arranged inside the plug 23, a portion of the discharge space 24 and one electrode 40 of an lamp vessel 3 of a discharge lamp according to a first preferred embodiment of the present invention are shown. The portion of the vessel wall 22, the portion of the plug 23, the portion of the molybdenum foil 25 arranged inside the plug 23 and the portion of the discharge space 24 as shown in FIG. 3 are also shown in FIG. 4, whereas the electrode 40 is also shown in FIG. 5.

The electrode 40 is massive, and is manufactured from a suitable conducting material, for example tungsten, whereas the plug 23 is manufactured from a non-conducting material such as quartz glass. A part of the electrode 40 is embedded in the plug 23, which is provided with a cavity 50 for receiving the electrode 40.

At one end, the electrode 40 comprises a base part 41 that is located inside the plug 23, and that has a cylindrical shape. At another end, the electrode 40 comprises a top part 42 that is located inside the discharge space 24, and that also has a cylindrical shape. Furthermore, the electrode 40 comprises an intermediate part 43 that extends between the base part 41 and the top part 42. The intermediate part 43 has a conical shape, and tapers in a direction going from the top part 42 to the base part 41.

The shape of the cavity 50 in the plug 23 is adjusted to the shape of the electrode 40, such that an inner surface 51 of the cavity 50 fits closely on an outer surface 44 of the electrode 40. Consequently, the cavity 50 comprises a conical section 52 for receiving the conical intermediate part 43 of the electrode 40, and a cylindrical section 53 for receiving the cylindrical base part 41 of the electrode 40.

According to an important aspect of the present invention, only the base part 41 of the electrode 40 is fixed to the plug 23, for example by means of bonding to the inner surface 51 of the cavity 50, mechanical anchoring or a connection the molybdenum foil 25, which connection may be realized by means of welding. At the intermediate part 43 of the electrode 40, no bonding is present, so that slip is allowed between this intermediate part 43 thus forming a slip part and the inner surface 51 of the cavity 50 in the plug 23.

In FIG. 6, a small portion of the vessel wall 22, a portion of one plug 23, a portion of the discharge space 24 and one electrode 60 of a lamp vessel 4 of a discharge lamp according to a second preferred embodiment of the present invention are shown. The portion of the vessel wall 22, the portion of the plug 23 and the portion of the discharge space 24 as shown in FIG. 6 are also shown in FIG. 7, whereas the electrode 60 is also shown in FIG. 8.

The electrode 60 is massive, and is manufactured from a suitable conducting material, whereas the plug 23 is manufactured from a non-conducting ceramic material. The electrode 60 extends through the plug 23, which is provided with a through-hole 70 for receiving the electrode 60, wherein the electrode 60 projects from the plug 23 at both ends of the plug 23.

At one end, the electrode 60 comprises a base part 61 that is partly located inside the plug 23, and that has a cylindrical shape. At another end, the electrode 60 comprises a top part 62 that is located inside the discharge space 24, and that also has a cylindrical shape. Furthermore, the electrode 60 comprises an intermediate part 63 that extends between the base part 61 and the top part 62. The intermediate part 63 has a conical shape, and tapers in a direction going from the top part 62 to the base part 61.

The shape of the through-hole 70 in the plug 23 is adjusted to the shape of the electrode 60, such that an inner surface 71 of the through-hole 70 fits closely on an outer surface 64 of the electrode 60. Consequently, the through-hole 70 comprises a conical section 72 for receiving the conical intermediate part 63 of the electrode 60, and a cylindrical section 73 for receiving the cylindrical base part 61 of the electrode 60.

According to an important aspect of the present invention, bonding between the outer surface 64 of the electrode 60 and the inner surface 71 of the through-hole 70 in the plug 23 is only present at the base part 61 of the electrode 60. In the shown example, the bonding is realized by means of a glass sleeve 80, of which an inner surface 81 fits closely on the outer surface 64 of the base part 61 of the electrode 60, and of which an outer surface 82 fits closely on the inner surface 71 of the cylindrical section 73 of the through-hole 70. At the intermediate part 63 of the electrode 60, no bonding is present, so that slip is allowed between this slip part forming intermediate part 63 and the inner surface 71 of the through hole 70 in the plug 23.

In FIGS. 9 and 10, the electrode 60 and a portion of the surrounding plug 23 are shown. The glass sleeve 80 is not shown in these figures. Instead, the bonding between the electrode 60 and the plug 23 at the base part 61 of the electrode 60 is depicted in a diagrammatical manner and indicated by means of reference numeral 35.

FIG. 9 diagrammatically shows the electrode 60 and a portion of the surrounding plug 23 at a relatively low temperature. When the discharge lamp is switched on, light and heat are generated in the discharge space 24. Under the influence of the heat, the temperature of both the electrode 60 and the plug 23 increase. As a result, the materials of both the electrode 60 and the plug 23 expand. In the process, the thermal expansion coefficient of the respective materials plays a very important role.

During the process of expanding, both an axial length and a diameter of the electrode 60 increase. In an ideal situation, in which the temperature of the electrode 60 is the same for all parts 61, 62, 63 of the electrode 60 and the intermediate part 63 is shaped as a complete cone of which only a tip is fixed to the plug 23, the increase of both the axial length and the diameter of the electrode 60 does not cause any stress build-up, because there is no bonding between the intermediate part 63 of the electrode 60 and the plug 23, and because the top part 62 of the electrode 60 can simply be displaced inside the discharge space 24. Moreover, the diameter of the intermediate part 63 of the electrode 60 increases in a direction going from the base part 61 to the top part 62. Consequently, the diameter of the conical section 72 of the through-hole 70 increases in a direction going from one end that communicates with the cylindrical section 73 of the through-hole 70 to another end that communicates with the discharge space 24. Due to these important factors of the present invention, the expanding material of the electrode 60 is squeezed from the through-hole 70, as it were, at the end that communicates with the discharge space 24. In the process, at the intermediate part 63 of the electrode 60, the outer surface 64 of the electrode 60 and the inner surface 71 of the through-hole 70 slip with respect to each other, so that stress build-up is avoided. Further, contact between the outer surface 64 of the intermediate part 63 of the electrode 60 and the inner surface 71 of the through-hole 70 is maintained, so that it is not possible for the filling of the discharge space 24 to enter the through-hole 70.

FIG. 10 diagrammatically shows the electrode 60 and a portion of the surrounding plug 23 at a relatively high temperature. When FIG. 10 is compared to FIG. 9, it can clearly be seen that expansion of the material of the electrode 60 leads to enlarged dimensions of the portion of the electrode 60 that is outside the plug 23. It will be understood that when the electrode 60 is cooled down and when the material of the electrode 60 contracts, the above-described procedure and effects take place in a reverse manner, and the electrode 60 is retracted, as it were, while contact between the outer surface 64 of the intermediate part 63 of the electrode 60 and the inner surface 71 of the through-hole 70 is maintained.

In a practical situation, the temperature of the top part 62 of the electrode 60 is higher than the temperature of the base part 61 of the electrode 60, as the top part 62 is located closest to the place where the heat is generated during operation of the lamp vessel 4, i.e. the place where the discharge arc is obtained. For example, the temperature at a free end of the top part 62 is 1700° C., whereas the temperature at a free end of the base part 61 is 900° C. Furthermore, the intermediate part 63 of the electrode 60 is not shaped as a complete cone of which only the tip is fixed to the plug 23, as in practice, an area instead of a point is needed to realize proper bonding. Instead, the intermediate part 63 is shaped as a truncated cone, wherein the side where the diameter is the smallest is connected to the base part 61, which is fixed to the inner surface 71 of the through-hole 70. Therefore, in practice, in spite of the fact that slip is allowed between the outer surface 64 of the electrode 60 and the inner surface 71 of the conical section 72, stresses are built up during expansion of the electrode 60. However, these stresses remain far below a level at which the stresses can lead to breaking of the plug 23.

Ideally, the intermediate part 43, 63 of the electrode 40, 60 is shaped as a complete cone, and the inner surface 51, 71 of the conical section 52, 72 of the cavity 50 or the through-hole 70 in the plug 23 is also shaped as a complete cone, wherein only a tip of the intermediate part 43, 63 of the electrode 40, 60 is fixed to a tip of the conical section 52, 72 of the cavity 50 or the through-hole 70 in the plug 23. In such a configuration of the electrode 40, 60 and the plug 23, no stress build-up occurs during expansion of the materials of the electrode 40, 60 and the plug 23, assuming that no temperature gradients are present. However, in practice, it is not possible to fix the electrode 40, 60 properly in the plug 23 by only attaching a point of the electrode 40, 60 to a point of the plug 23. In order to obtain a secure fixation of the electrode 40, 60 in the plug 23 on the one hand and to avoid as much as possible stress build-up during expansion of the materials of the electrode 40, 60 and the plug 23, the intermediate part 43, 63 of the electrode 40, 60 is shaped as a truncated cone, and the side where the diameter is the smallest is connected to the base part 41, 61, wherein the entire base part 41, 61 or a portion of the base part 41, 61 is fixed to the inner surface 51, 71 of the cavity 50 or the through-hole 70 in the plug 23.

In the shown examples, only the base part 41, 61 of the electrode 40, 60 is fixed to the plug 23. However, it is also possible that an adjacent portion of the conical intermediate part 43, 63 of the electrode 40, 60 is fixed to the plug 23. Slip between the inner surface 51, 71 of the cavity 50 or the through-hole 70 and the outer surface 44, 64 of the electrode 40, 60 may then only occur at a free portion of the intermediate part 43, 63, i.e. the portion that is not fixed to the plug 23. Consequently, only this portion of the intermediate part 43, 63 may be regarded as slip part of the electrode 40, 60. In situations in which both the base part 41, 61 of the electrode and an adjacent portion of the conical intermediate part 43, 63 of the electrode 40, 60 are fixed to the plug 23, the risk of breaking of the plug 23 is enlarged in comparison with situations in which only the base part 41, 61 of the electrode 40, 60 is fixed to the plug 23, but the said risk is still reduced in comparison with conventional situations in which the entire electrode is cylindrical.

The present invention is applicable in situations in which the thermal expansion coefficient of the material of the electrode 40, 60 is larger than the thermal expansion coefficient of the material of the plug 23, as well as in situations in which the thermal expansion coefficient of the material of the electrode 40, 60 is smaller than the thermal expansion coefficient of the material of the plug 23. For example, in case of the electrode 40, 60 being manufactured from tungsten and the plug 23 being manufactured from quartz glass, as is the case in the example as shown in FIGS. 3-5, the thermal expansion coefficient of the material of the electrode 40, 60 is larger than the thermal expansion coefficient of the material of the plug 23. However, in case of the plug 23 being manufactured from a ceramic material, as is the case in the example as shown in FIGS. 6-10, the thermal expansion coefficient of the material of the electrode 40, 60 is smaller than the thermal expansion coefficient of the material of the plug 23.

Within the scope of the present invention, the shape of the outer surface 44, 64 of the base part 41, 61 of the electrode 40, 60 does not necessarily need to be cylindrical. The same is true for the shape of the outer surface 44, 64 of the top part 42, 62 of the electrode 40, 60.

It will be clear to a person skilled in the art that the scope of the present invention is not limited to the examples discussed in the foregoing, but that several amendments and modifications thereof are possible without deviating from the scope of the present invention as defined in the attached claims.

In the foregoing, a lamp vessel 3, 4 of a discharge lamp is disclosed. The lamp vessel 3, 4 comprises a vessel wall 22 and two plugs 23 arranged at opposite ends of the lamp vessel 3, 4, which enclose a discharge space 24 filled with an ionisable filling. Furthermore, the lamp vessel 3, 4 comprises two electrodes 40, 60, wherein one part of each electrode 40, 60 extends in the discharge space 24 and another part of each electrode 40, 60 extends in a plug 23.

Both a base part 41, 61 and a top part 42, 62 of the electrode 40, 60 have a cylindrical outer surface 44, 64, whereas an intermediate part 43, 63 has a conical outer surface 44, 64. A part of an inner surface 51, 71 of the plug 23 fits closely on a part of the conical outer surface 44, 64 of the electrode 40, 60. Bonding between the electrode 40, 60 and the plug 23 is only present at the base part 41, 61 of the electrode 40, 60.

In case the electrode 40, 60 expands as a result of an increase of the temperature, the conical outer surface 44, 64 of the electrode 40, 60 slips with respect to the inner surface 51, 71 of the plug 23, wherein stresses between the electrode 60 and the plug 23 remain far below a level at which stresses can cause the plug 23 to break. In the process, contact between the plug 23 and the electrode 40, 60 is maintained. In this way, leaking out of the filling of the discharge space 24 is avoided.

1. A discharge lamp, comprising:
a sealed lamp vessel (3, 4) having a vessel wall (22) enclosing a discharge space (24) in which an ionisable filling is present, wherein the lamp vessel (3, 4) has two extended plugs (23); and
two electrodes (40, 60), wherein one part of each electrode (40, 60) extends in an aperture (50, 70) in a respective plug (23), wherein another part of each electrode (40, 60) extends in the discharge space (24), and wherein each electrode (40, 60) comprises a slip part (43, 63) having a conical outer surface (44, 64);
wherein an inner surface (51, 71) of the aperture (50, 70) fits closely on the conical outer surface (44, 64) of the slip part (43, 63) of the electrode (40, 60);
and wherein slip between the inner surface (51, 71) of the aperture (50, 70) and the conical outer surface (44, 64) of the slip part (43, 63) of the electrode (40, 60) is allowed.

2. A discharge lamp according to claim 1, wherein the electrode (40, 60) comprises a base part (41, 61) and the slip part forming an intermediate part (43, 63) having the conical outer surface (44, 64), wherein the base part (41, 61) is connected to the intermediate part (43, 63), at a side where the diameter of the intermediate part (43, 63) is the smallest, and wherein only the base part (41, 61) is fixed to the plug (23).

3. A discharge lamp according to claim 2, wherein the base part (41, 61) of the electrode (40, 60) has a cylindrical outer surface (44, 64).

4. A discharge lamp according to claim 2, wherein bonding between the outer surface (64) of the electrode (60) and the inner surface (71) of the aperture (70) is realized by means of a glass sleeve (80) of which an inner surface (81) fits closely on the outer surface (64) of the base part (61) of the electrode (60), and of which an outer surface (82) fits closely on the inner surface (71) of the aperture (70).

5. A discharge lamp according to claim 2, wherein the aperture (50, 70) in the plug (23) comprises a conical section (52, 72) having a conical inner surface (51, 71) for receiving the intermediate part (43, 63) of the electrode (40, 60), and a cylindrical section (53, 73) having a cylindrical inner surface (51, 71) for receiving the base part (41, 61) of the electrode (40, 60).

6. A discharge lamp according to claim 1, wherein the electrode (40, 60) comprises a top part (42, 62) and an intermediate part (43, 63) having a conical outer surface (44, 64), wherein the top part (42, 62) is connected to the intermediate part (43, 63) of the electrode (40, 60), at a side where the diameter of the intermediate part (43, 63) is the largest.

7. A discharge lamp according to claim 6, wherein the top part (42, 62) has a cylindrical outer surface (44, 64).
